(19) United States
(12) Patent Application Publication
(10) Pub. No.: US 2024/0297964 A1
(43) Pub. Date: Sep. 5, 2024

(54) TRACKING SYSTEM, TRACKING METHOD AND STORAGE MEDIUM

(71) Applicant: TOYOTA JIDOSHA KABUSHIKI KAISHA, Toyota-shi (JP)

(72) Inventors: Hsuan-Kung YANG, Tokyo (JP); Hitoshi KAMADA, Tokyo (JP); Norimasa KOBORI, Tokyo (JP)

(73) Assignee: TOYOTA JIDOSHA KABUSHIKI KAISHA, Toyota-shi (JP)

(21) Appl. No.: 18/589,760

(22) Filed: Feb. 28, 2024

(30) Foreign Application Priority Data
Mar. 3, 2023 (JP) 2023-032593

(51) Int. Cl. H04N 7/18; G06T 7/292

(52) U.S. Cl. CPC H04N 7/181; G06T 7/292

(57) ABSTRACT

A tracking system that includes a plurality of tracking devices and a server device. Each of the tracking devices: tracks an object; transmits tracking information, which includes at least features and an identifier of the object, to nearby tracking devices and the server device; determines whether an object coincided with an object specified by the transmitted tracking information is included in the currently tracked objects; replaces the identifier of the object with the identifier included in the tracking information; and transmits the coincidence information.

### CROSS REFERENCE TO THE RELATED APPLICATION

This application claims the benefit of Japanese Patent Application No. 2023-032593, filed on Mar. 3, 2023, which is hereby incorporated by reference herein in its entirety.

### BACKGROUND

### Technical Field

The present disclosure relates to a tracking system, a tracking method and a storage medium.

### Description of the Related Art

An apparatus disclosed in Japanese Patent Application Publication No. 2017-21753 acquires a plurality of person images captured by a plurality of cameras of which imaging regions are different from each other, and similarity information related to similarity among the plurality of person image, and in a case where similarity between two person images is higher than a predetermined threshold, a graph generation unit of the apparatus generates an edge connecting the two person images.

### SUMMARY

It is an object of an aspect of the present disclosure to provide a technique to improve scalability of a tracking system.

An aspect of the present disclosure is a tracking system comprising: a plurality of tracking devices, each including an imaging apparatus; a tracking unit configured to track an object based on a captured image acquired by the imaging apparatus; a tracking information transmission unit configured to transmit tracking information, which includes at least features and an identifier of the object, to nearby tracking devices and the server device; a determination unit configured to, in a case of receiving the tracking information from another tracking device, determine whether an object coincided with the object specified by the tracking information transmitted from the other tracking device is included in the currently tracked objects, and an update unit configured to, in a case where it is determined that an object coincided with the object specified by the tracking information transmitted from the other tracking device is included in the currently tracked objects, replace an identifier of the object with the identifier included in the tracking information, and transmit to the server device coincidence information which indicates the object received from the nearby tracking device coincides with a currently tracked object; and a server device including a storage unit configured to store the tracking information transmitted from the tracking device as a graph structure, and store such that nodes of tracking information which are indicated to coincide with each other in the coincidence information are connected, and a node of identification information of the object is connected to a node of each tracking information.

According to the aspect of the present disclosure, scalability of the tracking system can be ensured.

### BRIEF DESCRIPTION OF THE DRAWINGS

FIG. 1A is a diagram for describing an overview of a tracking system according to an embodiment, and FIG. 1B is a diagram for describing a graph database of tracking information in a server device;

FIG. 2A is a diagram depicting a configuration of a tracking device according to an embodiment, and FIG. 2B is a diagram depicting a configuration of a server device;

FIGS. 3A to 3C are flow charts depicting processing flows performed by the tracking device according to an embodiment;

FIGS. 4A to 4D are flow charts depicting processing flows performed by the server device according to an embodiment; and

FIGS. 5A to 5D are diagrams for describing an example of updating the graph database by the server device according to an embodiment.

### DESCRIPTION OF THE EMBODIMENTS

A technique to identify a same person out of persons captured by a plurality of cameras, and track the person in a wide range has been proposed. To construct such a tracking system in a large scale, a distributed system having scalability need to be constructed. In a prior art, such as Japanese Patent Application Publication No. 2017-21753, however, all the processing is performed by the server device, which is not scalable. It is also demanded for the tracking system to correctly manage a same person in a wide range and to easily retrieve a specific person.

With the foregoing in view, it is an object of the present disclosure to improve scalability in a tracking system that includes a plurality of tracking devices.

An embodiment of the present disclosure is a tracking system that includes a plurality of tracking devices and a server device.

Each of the plurality of tracking devices includes an imaging apparatus, a tracking unit, a tracking information transmission unit, a determination unit and an update unit. The tracking unit tracks an object based on a captured image acquired by the imaging apparatus. The tracking information transmission unit transmits tracking information, which includes at least features and an identifier of the object, to nearby tracking devices and the server device. The identifier here may be an identifier unique to the system, such as a universally unique identifier (UUID). In a case where the tracking information is received from another tracking device, the determination unit determines whether an object, which coincides with an object specified by the tracking information transmitted from the other tracking device, is included in the currently tracked objects. In a case where it is determined that an object, which coincides with the object specified by the tracking information transmitted from the other tracking device, is included in the currently tracked objects, the update unit replaces the identifier of the object with the identifier included in the tracking information, and transmits, to the server device, the coincidence information which indicates that the object received from the nearby tracking device and the currently tracked object coincide with each other.

The server device includes a storage device, which stores the tracking information, transmitted from the tracking device, as a graph structure, and stores with connecting a node of the tracking information of which coincidence is indicated in the coincidence information, and connecting a node of the identification information of the object to the node of each tracking information.

Since the determination of a same person is executed distributedly by a plurality of nearby tracking devices which are linked together, the processing load is not concentrated even if a number of tracking devices increases. Further, the server device uses a graph structured database, hence high speed data retrieval is possible even if a number of data is high, and moreover, an identification information node is connected to each tracking information node, which further increases the speed of retrieval using the identification information.

In the present disclosure, in a case where an imaging range acquired by the imaging apparatus overlaps with a nearby tracking device, the tracking information transmission unit of the tracking device may periodically transmit the tracking information to this nearby tracking device among the nearby tracking devices. In a case where an imaging range acquired by the imaging apparatus does not overlap with a nearby tracking device, the tracking information transmission unit of the tracking device may transmit the tracking information to this nearby tracking device, among the nearby tracking devices, when an exit event of the object is generated.

In a case where imaging ranges of two tracking devices overlap, the object may be captured by both of the tracking devices, hence periodical information transmission is preferable. In a case where imaging ranges of two tracking devices do not overlap, on the other hand, tracking by one tracking device completes first, then tracking by the other tracking device starts, that is, it is sufficient to transmit the tracking information after the exit even is generated.

In the present disclosure, the server device may further include a verification unit that verifies a connection relationship of the tracking information in the storage unit, and in a case where an inconsistent connection relationship is discovered, the verification unit notifies the user or corrects the inconsistent connection relationship. An example of the inconsistent relationship is a case where a tracking target is tracked in different tracking devices at the same timing, that is, a case where one tracking information node is linked to a plurality of tracking information nodes. Another example of the inconsistent connection relationship is a case where a tracking target is moving between tracking devices, of which distance is practically impossible for the tracking target to move between. By performing such corrections, the server device can maintain a consistency of the database.

In the present disclosure, the server device may include an image acquisition unit that acquires an image capturing an object, an identifier specification unit that specifies an identifier of the object in the image, and a retrieval unit that acquires the tracking information of the object in the image from the storage unit, and outputs the tracking information. The identifier of the object may be specified by the server device alone, or may be specified by another device so that the server device simply receives this result. According to the present disclosure, the tracking information of a specific object can be retrieved at high-speed.

Other embodiments of the present disclosure are the tracking device and the server device. Other embodiments of the present disclosure are a tracking method performed by the tracking system, a processing method performed by the tracking device, and a processing method performed by the server device. Another aspect of the present disclosure is a computer program to cause the tracking system, the tracking device or the server device to execute the above mentioned processing method.

Embodiments of the present disclosure will now be described based on the drawings. The configurations of the following embodiments are examples, and the present disclosure is not limited to the configurations of the embodiments.

### System Overview

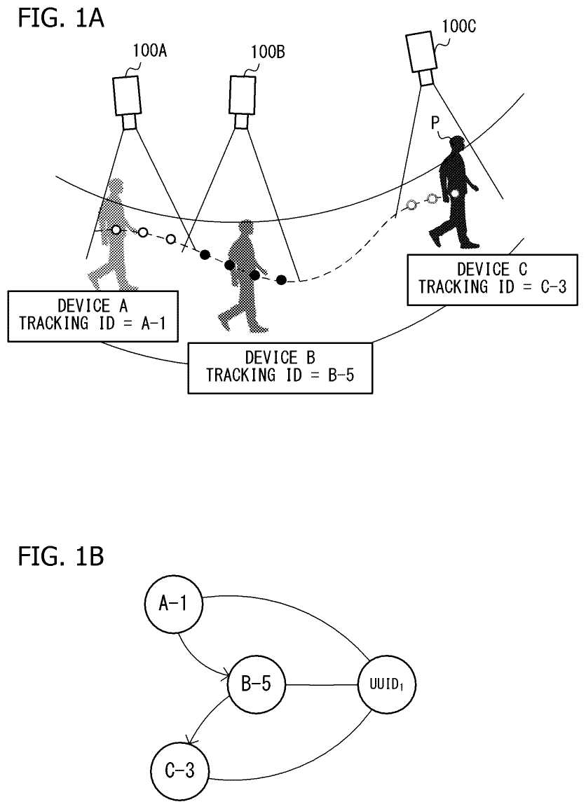

FIG. 1A is a diagram for describing an overview of a tracking system according to an embodiment. The tracking system according to this embodiment tracks a person as an object, where a plurality of tracking devices assign a same identifier to a same person, so that the movement of the person beyond the imaging range of each tracking device can be tracked. In the case of the example in FIG. 1A, the tracking system includes three tracking devices: 100A, 100B and 100C. The camera imaging ranges of the tracking device 100A and the tracking device 100B partially overlap, and the camera imaging range of the tracking device 100C does not overlap with the camera imaging ranges of the other devices.

Here it is assumed that a person P moved as illustrated. Each tracking device shares the feature information of the tracking target person with nearby tracking devices, so as to determine a person who is the same as the person tracked by another device.

Each tracking device transmits, to a server device 200, the tracking information on a tracking person from the tracking start to the tracking end. The server device 200 stores the tracking information as a graph structured database, as illustrated in FIG. 1B. Here it is assumed that a tracking instance (a series of tracking information from the tracking start to the tracking end) of the person P at each tracking device 100A, 100B and 100C is managed by assigning an identifier (ID) of A-1, B-5 and C-3 respectively. In accordance with the moving route of the person P, the server device 200 sets up a link from the node A-1 to the node B-5, and sets up a link from the node B-5 to the node C-3. Then by tracing the graph, the tracking information related to the movement of the person P can be easily retrieved. Further, a node having a unique ID (UUID₁ in this case) is linked with each node: A-1, B-5 and C-3. Thereby the server device 200 can easily perform retravel using the unique ID as well.

The tracking system according to this embodiment determines the same person only among the nearby tracking devices that identify a same person, hence the processing load to determine a same person can be distributed, and scalability can be ensured. Further, the server device stores the tracking information using the graph structured database, as mentioned above, hence consistency of the tracking information can be easily maintained, and retrieval thereof also becomes easy.

### Configuration

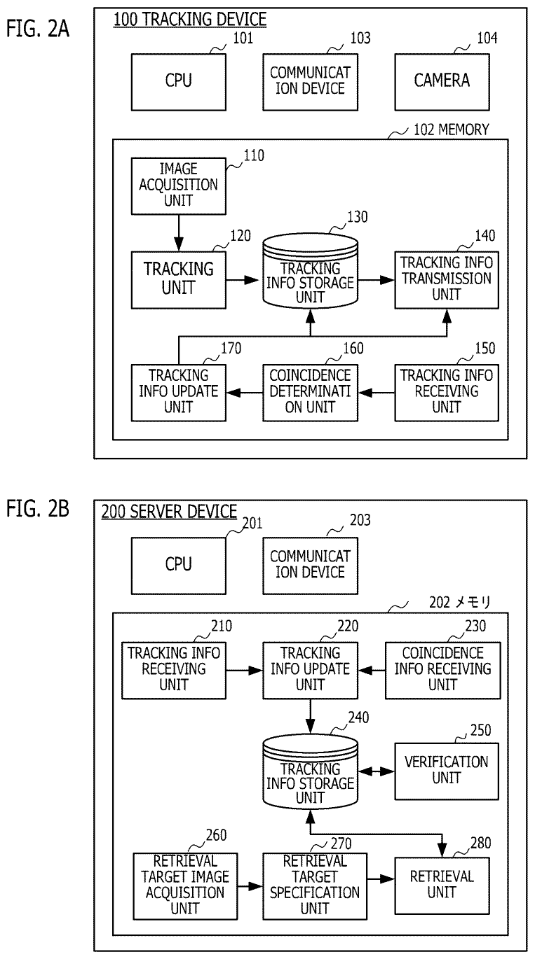

A tracking system according to this embodiment is constituted of a plurality of tracking devices 100, and a server device 200. FIG. 2A is a block diagram of the tracking device 100, and FIG. 2B is a block diagram of the server device 200.

The tracking device 100 is a computer (information processing device) which includes a CPU 101, a memory 102, a communication device 103, and a camera (imaging apparatus) 104. The memory 102 stores programs that the CPU 101 can execute. By the CPU 101 executing the programs, the tracking device 100 functions as: an image acquisition unit 110, a tracking unit 120, a tracking information storage unit 130, a tracking information transmission unit 140, a tracking information receiving unit 150, a coincidence determination unit 160, and a tracking information update unit 170. The camera 104, the CPU 101, the memory 102 and the communication device 103 may be disposed in the same casing, or may be disposed in different casings which are geographically distant from each other. The tracking device 100 is configured to be communicable with the server device 200, and with at least other nearby tracking devices 100.

The server device 200 is a computer (information processing device) which includes a CPU 201, a memory 202, and a communication device 203. The memory 202 stores programs that the CPU 201 can execute. By the CPU 201 executing the programs, the server device 200 functions as: a tracking information receiving unit 210, a tracking information update unit 220, a coincidence information receiving unit 230, a tracking information storage unit 240, a verification unit 250, a retrieval target image acquisition unit 260, a retrieval target specification unit 270 and a retrieval unit 280.

Each of the functional units will be described in detail later with reference to other drawings. A part or all of the functions units may be implemented by a dedicated circuit or device.

### Processing

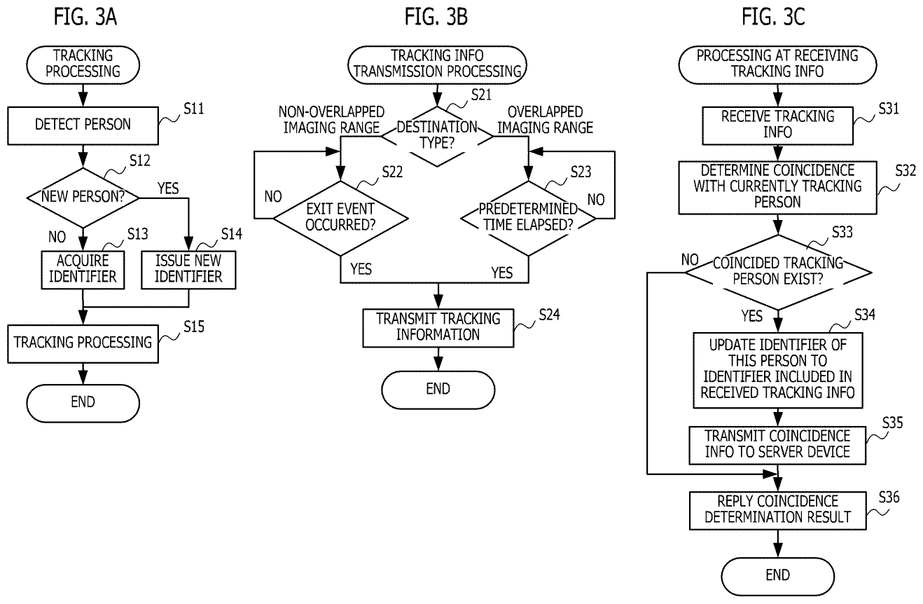

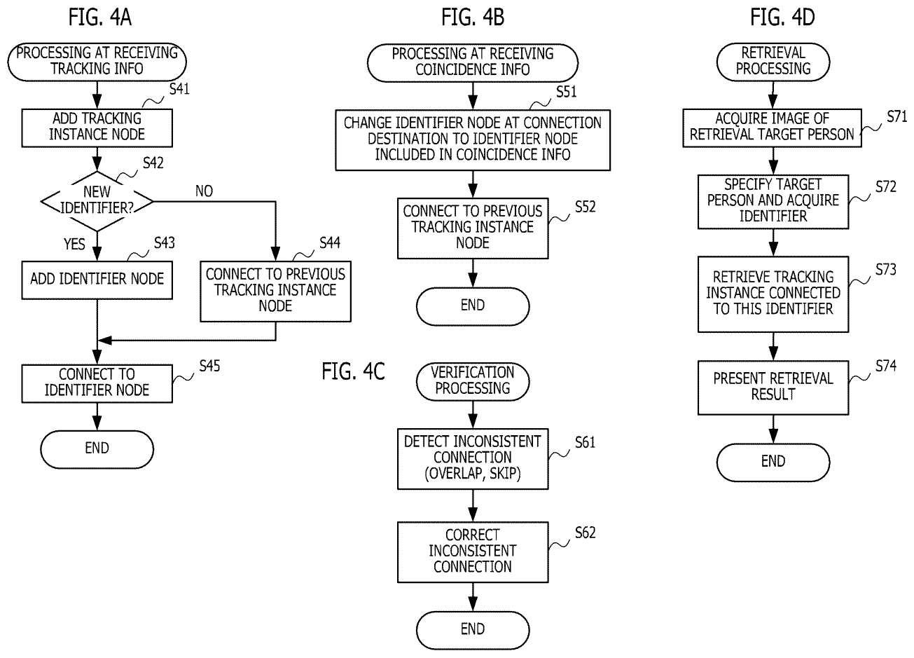

Processing flows of the tracking device 100 and the server device 200 will be described with reference to the drawings. FIGS. 3A to 3C are flow charts depicting the flows of tracking processing, tracking information transmission processing and processing upon receiving tracking information, which are performed by the tracking device 100 respectively. FIGS. 4A to 4D are flow charts depicting the flows of the processing upon receiving tracking information, processing upon transmitting coincidence information, verification processing, and retrieval processing, which are performed by the server device 200 respectively. These processing flows are implemented by the CPU of the tracking device 100 or the server device 200 executing the programs. Therefore the CPU corresponds to a control unit.

### Tracking Processing (Tracking Device)

The tracking processing performed by the tracking device 100 will be described with reference to FIG. 3A. The tracking processing is processing where an image captured by the camera 104 is analyzed, a new person (tracked object) which entered the image is detected, and movement of the detected person is tracked.

In step S11, the tracking unit 120 acquires a captured image from the camera 104 via the image acquisition unit 110, and detects a person other than the currently tracking person in the image. The tracking unit 120 also acquires feature information of the detected person. The feature information of a person that can be used may be any information by which this person can be specified, such as information indicating the features of parts of the face, and information indicating the features of the body (e.g. contour, color, brightness gradient).

In step S12, the tracking unit 120 determines whether the person detected in step S11 has already been tracked in the tracking system, or is a new person. This determination can be performed by checking whether a person having the feature value coinciding with the feature value acquired in step S11 has ever been tracked in the tracking system. As mentioned later, each tracking device 100 receives from a nearby tracking device 100 the tracking information, including the feature information of a person tracked by the nearby tracking device, and stores the tracking information in the tracking information storage unit 130. Therefore the tracking unit 120 can perform the determination in step S12 by determining whether feature information, having a feature coinciding with the feature information of the detected person, has been stored in the tracking information storage unit 130. Even if a detected person has already been tracked, the tracking device 100 determines that the detected person is a new person if the tracking device 100 did not acquire the tracking information of this person.

If the determination in step S12 is NO, that is, if the detected person is a person who has already been tracked, the tracking unit 120 acquires, in step S13, an identifier which was used when this person was tracked in the past. As mentioned later, this identifier is a globally unique identifier, and is included in the tracking information.

If the determination in step S12 is YES, that is, if the detected person is a new person who has never been tracked, then in step S14, the tracking unit 120 issues a new globally unique ID for this person.

In step S15, the tracking unit 120 tracks a target person in an image acquired from the camera 104 via the image acquisition unit 110. As the tracking information, the tracking unit 120 stores feature information of the tracking target person, image of the person, position of the bounding box (detection position), detection time and identifier, which are acquired from each frame image, in the tracking information storage unit 130. The frame image or information indicating a storage location of this frame image, acquired from the camera 104, may be included in the tracking information and stored.

The tracking device 100 assigns a tracking identifier (tracking ID) to a series of tracking information (tracking instance) from the tracking device 100 entering the camera image range to the tracking device 100 exiting from the camera imaging range. This tracking ID is an identifier, which is different depending on the tracking instance even if the same person is being tracked, unlike the unique ID of each person. The tracking ID may be a combination of an identifier of the tracking device 100 and a unique identifier within the tracking device 100. A-1, B-5 and C-3 in FIG. 1A are examples of tracking IDs. This tracking ID is also included in the tracking information and stored in the tracking information storage unit 130.

Tracking Info. Transmission Processing (Tracking Device)

The tracking information transmission processing performed by the tracking information transmission unit 140 will be described with reference to FIG. 3B. The tracking information transmission unit 140 transmits the tracking information to nearby tracking devices at predetermined timings. The transmission timing is different depending on the transmission destination tracking device. This processing will be described below with reference to the drawing.

In step S21, the tracking information transmission unit 140 determines a type of a transmission destination tracking device 100. Here it is determined whether or not the camera imaging range of the transmission destination tracking device 100 overlaps with the camera imaging range of this tracking device. Processing advances to step S22 if the imaging ranges do not overlap, and processing advances to step S23 if the imaging ranges overlap.

Information on whether or not the camera imaging ranges overlap is either stored in each tracking device 100 in advance as the camera installation information, or is stored in the server device 200, so that the tracking device 100 can acquire it when necessary. The camera installation information may include information other than the information on whether or not the camera imaging ranges overlap, such as the installation location, and the distance between two tracking devices.

Step S22 is performed if the camera imaging range does not overlap with the tracking device to which the tracking information is transmitted. In step S22, the tracking information transmission unit 140 determines whether or not an exit event of any of the currently tracking persons is generated. Processing advances to step S24 if the exit event is generated, and if the exit event is not generated, processing returns to step S22, and the tracking information transmission unit 140 waits for the generation of the exit event. For example, in a case where a tracking person cannot be detected from an image continuously for a predetermined time (or for a predetermined number of frames), the tracking unit 120 generates an exit event for this person.

Step S23 is performed in a case where the camera imaging range overlaps with the tracking device, to which the tracking information is transmitted. The tracking information transmission unit 140 determines whether or not a predetermined time has elapsed since the previous transmission of the tracking information. This transmission cycle (predetermined time) may be arbitrary. Processing advances to step S24 if the predetermined time has elapsed, and if the predetermined time has not elapsed, processing returns to S23, and the tracking information transmission unit 140 waits for the time to elapse.

In step S24, the tracking information transmission unit 140 transmits the tracking information stored in the tracking information storage unit 130 to nearby tracking devices via the communication device 103. In a case of transmitting the tracking information in response to an exit event, the tracking information transmission unit 140 may transmit the tracking information of the exited person, and in a case of transmitting the tracking information periodically, the tracking information transmission unit 140 may transmit the tracking information of a currently tracking person and the tracking information of a person who exited after the previous transmission. The tracking information to be transmitted may include, for example, a globally unique ID of the tracking target person, a tracking ID, feature information, an image of the person, a position of the boundary box, and a detection time.

The tracking information transmission unit 140 also transmits tracking information to the server device 200. The transmission timing of the tracking information to the server device 200 is not especially limited, and may be transmitted when an exit event is generated, for example.

Tracking Info. Reception Time Processing (Tracking Device)

The processing performed by the tracking device 100 when tracking information is received from a nearby tracking device will be described with reference to FIG. 3C.

In step S31, the tracking information receiving unit 150 receives tracking information from a nearby tracking device via the communication device 103. As mentioned above, the tracking information may include, for example, a globally unique ID of the tracking target person, a tracking ID, feature information, an image of the person, a position of the boundary box, and a detection time.

In step S32, the coincidence determination unit 160 determines whether or not a person coincided with a person specified by the received tracking information is included in the persons whom the tracking unit 120 is currently tracking. Specifically, the coincidence determination unit 160 compares the feature information of a currently tracking person stored in the tracking information storage unit 130, and the feature information included in the received tracking information, and if the similarity is a threshold or more, the coincidence determination unit 160 determines that these persons coincide with each other.

Processing advances to step S34 if there is a coincided tracking target person in step S33, and processing advances to step S36 if not.

In step S34, the tracking information update unit 170 updates the tracking information storage unit 130 so that the globally unique ID of a person of which coincidence was determined is updated to the globally unique ID included in the received tracking information. Further, the tracking information update unit 170 may store the tracking ID included in the received tracking information as a previous tracking instance of the currently tracking person.

In step S35, the tracking information update unit 170 transmits coincidence information which indicates that the currently tracking person and the person indicated by the received tracking information coincide, to the server device 200 via the tracking information transmission unit 140. The coincidence information includes, for example, the tracking ID of the currently tracking person, the globally unique ID which has been in use, and the globally unique ID included in the received tracking information. The coincidence information may include a previous tracking ID (included in the received tracking information) in addition to the tracking ID of the current tracking person.

In step S36, the coincidence determination unit 160 replies the result of the coincidence determination to the tracking device which transmitted the tracking information via the tracking information transmission unit 140. The content of the reply includes information on whether or not there is a currently tracking person who coincides with the person indicated in the transmitted tracking information, and may further include the tracking ID, feature information, and the like. By transmitting the coincidence determination result like this, the tracking device 100 at the transmission source can omit the step of transmitting the tracking information again.

### Processing Upon Receiving Tracking Info (Server Device)

The processing upon receiving tracking information performed by the server device 200 will be described with reference to FIG. 4A. This processing is executed when the tracking information receiving unit 210 received tracking information from any one of the tracking devices 100, and the server device 200 stores the tracking information in the tracking information storage unit 240. Here the tracking information storage unit 240 stores the tracking information as a graph structured database. It will be described below how the graph database is updated when the tracking information is received.

In step S41, the tracking information update unit 220 additionally stores a node of the tracking instance in the tracking information storage unit 240. Specifically, the node specified by the tracking ID is added to the graph database. This node may include other tracking information, such as feature information, an image of the person, a position of the boundary box, and detection time.

In step S42, the tracking information update unit 220 determines whether the globally unique ID included in the tracking information is an ID existing in the database, or is a new ID. Processing advances to step S43 if it is a new ID, and processing advances to S44 if not.

Step S43 is processing that is executed in a case where the tracking instance this time has a new globally unique ID. In step S43, the tracking information update unit 220 adds the new node having the globally unique ID included in the tracking information to the graph database.

Step S44 is processing that is executed in a case where the tracking instance this time has a conventional globally unique ID. In step S44, the tracking information update unit 220 connects via a link the node of the tracking instance specified by the previous tracking ID included in the tracking information and the node of the tracking instance added in step S41.

In step S45, the tracking information update unit 170 connects via a link the node of the tracking instance added in step S41 and the node of the globally unique ID (which was added in step S43 or is conventional) indicated in the tracking information.

### Processing Upon Receiving Coincidence Info (Server Device)

The processing upon receiving coincidence information performed by the server device 200 will be described with reference to FIG. 4B. This processing is executed when the coincidence information receiving unit 230 received coincidence information from any one of the tracking devices 100, and the tracking information update unit 220 updates the graph database in response to the coincidence information.

In step S51, the tracking information update unit 220 updates the graph database based on the coincidence information received by the coincidence information receiving unit 230. The coincidence information includes the information that a person of a certain tracking instance A coincides with a person of another tracking instance B, and a globally unique ID which is assigned to this person. The tracking information update unit 220 changes the node of the globally unique ID, to be connected to the node of the tracking instance A, to the node of the globally unique ID indicated in the coincidence information.

In step S52, the tracking information update unit 220 connects the node of the tracking instance A and the node of the tracking instance B via a link.

### Update Example of Graph Database

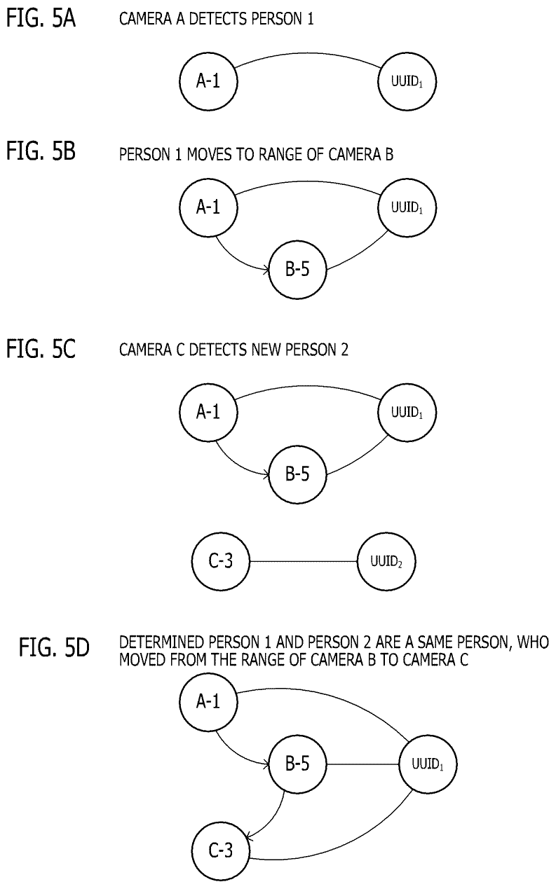

An update example of the graph database stored in the tracking information storage unit 240 will be described with reference to FIGS. 5A to 5D.

FIG. 5A indicates a database when the tracking device 100A (see FIG. 1A) starts a new tracking of a person as a tracking instance A-1, and a globally unique ID UUID₁, is assigned to this person. Based on the tracking information transmitted from the tracking device 100A, the tracking information update unit 170 adds the node of the tracking instance A-1 (S41), adds the node of the globally unique ID UUID₁ (S43), and connects these nodes (S45).

FIG. 5B indicates a database when the tracking device 100B tracks the same person. It is assumed that based on the tracking information transmitted from the tracking device 100A, the tracking device 100B has recognized that the person of the tracking instance B-5 is the same as the person of the tracking instance A-1. Therefore the tracking information transmitted from the tracking device 100B to the server device 200 indicates that the globally unique ID of the tracking instance B-5 is UUID₁. Based on the tracking information transmitted from the tracking device 100B, the tracking information update unit 170 adds the node of the tracking instance B-5 (S41), and connects the node of the tracking instance B-5 and the node of the previous tracking instance A-1 (S44). Further, the tracking information update unit 170 connects the node of the tracking instance B-5 to the node of the globally unique ID UUID₁ (S45).

FIG. 5C indicates a database when the tracking device 100C tracks the same person. At this point, however, it is assumed that the tracking device 100C has not yet recognized that this person is the same as the person of the tracking instances A-1 and B-5, and has assigned the globally unique ID UUID₂ to this person who is regarded as a new person. Based on the tracking information transmitted from the tracking device 100C, the tracking information update unit 170 adds the node of the tracking instance C-3 (S41), further adds the node of the globally unique ID UUID₂ (S43), and connects these nodes (S45).

FIG. 5D indicates a database after the tracking device 100C recognized that the person of the tracking instance C-3 is the same as the person of the tracking instances A-1 and B-5, and transmitted the coincidence information to the server device 200. Based on the coincidence information transmitted from the tracking device 100C, the tracking information update unit 170 changes the node, to which the tracking instance C-3 is connected from the node with the globally unique ID UUID₁, to the node of the globally unique ID UUID₂ (S51). Further, the tracking information update unit 170 connects the node of the tracking instance B-5 and the node of the tracking instance C-3 (S52).

By updating the graph database of the server device 200 based on the tracking information and the coincidence information in this way, even if the same person is temporarily recorded as a different person, the same person can be finally recorded as the same person.

### Verification Processing (Server Device)

The verification processing for the graph database performed by the verification unit 250 of the server device 200 will be described with reference to FIG. 5C.

In step S61, the verification unit 250 detects an inconsistent connection in the graph database. An example of the inconsistent connection is a case where, in a graph database, one tracking instance node is linked to tracking instance nodes of a plurality of tracking devices, of which camera imaging ranges do not overlap. If the camera imaging ranges do not overlap, a tracking instance node should be linked with one tracking instance node. This kind of error is generated if the coincidence determination based on the feature information is incorrect. The verification unit 250 regards such a connection as the inconsistent connection.

Another example of the inconsistent connection is a case where a tracking target person is moving between tracking devices of which distance is so long that shift is actually impossible. This kind of shift does not actually occur, hence the verification unit 250 regards such a connection as the inconsistent connection.

In step S62, the verification unit 250 corrects the inconsistent connection in the graph database. An example of the correction is deleting the inconsistent connection (link). Another example of the correction is replacing the inconsistent connection with a correct connection.

### Retrieval Processing (Server Device)

FIG. 5D indicates the retrieval processing for a person performed by the server device 200.

In step S240, the retrieval target image acquisition unit 260 acquires an image capturing a retrieval target person. The retrieval target image acquisition unit 260 may acquire this image from another device via the network, or may acquire this image by reading from the storage medium, or may acquire this image from a camera of the server device 200.

In step S72, the retrieval target specification unit 270 specifies the retrieval target person, and acquires a globally unique ID of this person. The person can be specified by extracting feature information of the person in the image, and searching for a person who has the same feature information as this feature information. The server device 200 has a storage unit where feature information of a person is stored in association with a globally unique ID which is used in the graph database, and acquires the globally unique ID of the retrieval target person with reference to this storage unit. According to another embodiment, the retrieval target specification unit 270 may transmit an image capturing the retrieval target person or feature information of this person to an external device, and acquire the globally unique ID of this person thereby.

In step S73, the retrieval unit 280 searches the graph database in the tracking information update unit 220, and retrieves a tracking instance connected to the globally unique ID acquired in step S72. In this retrieval, if such conditions as geographic range and time range of the retrieval are specified, the retrieval unit 280 retrieves only a tracking instance that satisfies these conditions. In the graph database, each tracking instance node is connected to a globally unique ID node, so it is easy to retrieve a tracking instance of a person having the specified globally unique ID.

In step S74, the retrieval unit 280 presents the retrieval result. The retrieval result may be outputted to the screen, or may be transmitted to another device.

### Effect of Embodiment

According to the present embodiment, the tracking device determines coincidence of the tracking target person in cooperation with the nearby tracking devices, and the server device does not perform the coincidence determination processing. Therefore load on the server device, to determine coincidence, does not increase even if a number of tracking devices increases, and therefore scalability of [the tracking system] is implemented.

The server device manages the tracking information using the graph structured database. It is not easy to manage information on tracking using a table structured database (relational database), but the management becomes easy if the graph database is used. For example, by connecting the nodes of tracking instances, it becomes easy to sequentially acquire tracking instances in accordance with the movement of the tracking target. Further, a node having a globally unique ID is connected to each of the tracking instances, hence retrieval processing using the globally unique ID is easy. This also means that it is easy to extract retrieval information of a specific person from the graph database.

Furthermore, the tracking device determines the coincidence of the tracking target and notifies the result to the server device, hence even if different globally unique IDs are assigned to a same person, the database could be updated such that ultimately the same globally unique ID is assigned to the same person.

### Other Embodiments

The above embodiment is merely an example, and the present disclosure may be appropriately changed within a scope not departing from the spirit thereof.

In the embodiment described above, an example of the retrieval target is a person, but in another embodiment the retrieval target may be an object other than a person. Such a retrieval target may be a vehicle, a flying object, an animal, and the like, for example, but are not limited thereto.

The present disclosure can also be implemented by supplying a computer program that provides the functions described in the above embodiment to a computer, and at least one processor of this computer reading and executing this program. Such a computer program may be provided to the computer as a non-transitory computer-readable storage medium that can be connected to the system bus of the computer, or may be provided to the computer via a network. The non-transitory computer-readable storage medium includes, for example, such a disk as a magnetic disk (e.g. Floppy® disk, hard disk drive (HDD)), an optical disk (e.g. CD-ROM, DVD disk, Blu-ray disk), a real-only memory (ROM), a random access memory (RAM), EPROM, EEPROM, a magnetic card, flash memory, an optical card, and any other type of medium appropriate for storing electronic instructions.

What is claimed is:

1. A tracking system comprising:
a plurality of tracking devices, each including an imaging apparatus;
a tracking unit configured to track an object based on a captured image acquired by the imaging apparatus;
a tracking information transmission unit configured to transmit tracking information, which includes at least features and an identifier of the object, to nearby tracking devices and a server device;
a determination unit configured to, in a case of receiving the tracking information from another tracking device, determine whether an object coincided with the object specified by the tracking information transmitted from the other tracking device is included in the currently tracked objects, and
an update unit configured to, in a case where it is determined that an object coincided with the object specified by the tracking information transmitted from the other tracking device is included in the currently tracked objects, replace an identifier of the object with the identifier included in the tracking information, and transmit to the server device coincidence information which indicates the object received from the nearby tracking device coincides with a currently tracked object; and
a server device including a storage unit configured to store the tracking information transmitted from the tracking device as a graph structure, and store such that nodes of tracking information which are indicated to coincide with each other in the coincidence information are connected, and a node of identification information of the object is connected to a node of each tracking information.

2. The tracking system according to claim 1,
wherein the tracking information transmission unit of the tracking device periodically is configured to transmit the tracking information, to a nearby tracking device of which an image range overlaps with that of the imaging apparatus, among the nearby tracking devices, and
wherein the tracking information transmission unit of the tracking device is configured to transmit the tracking information in accordance with an exit event of the object, to a nearby tracking device of which the imaging range does not overlap with that of the imaging apparatus, among the nearby tracking devices.

3. The tracking system according to claim 1, wherein the server device further includes a verification unit configured to verify a connection relationship of the tracking information in the storage unit, and in a case where an inconsistent relationship is discovered, notifies the inconsistency to the user, or corrects the inconsistent connection relationship.

4. The tracking system according to claim 1, wherein the server device includes:
an image acquisition unit configured to acquire an image capturing an object;
an identifier specification unit configured to specify an identifier of an object in the image; and
a retrieval unit configured to acquire tracking information of an object in the image from the storage unit and output the tracking information.

5. A tracking method used by a tracking system which includes a plurality of tracking devices and a server device, wherein
each of the plurality of tracking devices executes:
a tracking step of tracking an object based on a captured image acquired by an imaging apparatus;
a tracking information transmission step of transmitting tracking information, which includes at least features and an identifier of the object, to nearby tracking devices and the server device;
a determination step of, in a case of receiving the tracking information from another tracking device, determining whether an object coincided with the object specified by the tracking information is included in currently tracked objects; and
an update step of, in a case where it is determined that an object coincided with the object specified by the tracking information is included in the currently tracked objects, replacing an identifier of the object with the identifier included in the tracking information and transmitting to the server device coincidence information which indicates the object received from the nearby tracking device coincides with a currently tracked object, wherein
the server device executes:
a storage step of storing the tracking information transmitted from the tracking device as a graph structure, and storing such that nodes of tracking information which are indicated to coincide with each other in the coincidence information are connected and a node of the identification information of the object is connected to a node of each tracking information.

6. A non-transitory computer-readable storage medium storing a program used by a tracking system, which includes a plurality of tracking devices and a server device, the program causing the tracking device to execute:
a tracking step of tracking an object based on a captured image acquired by an imaging apparatus;
a tracking information transmission step of transmitting tracking information, which includes at least features and an identifier of the object, to nearby tracking devices and the server device;
a determination step of, in a case of receiving the tracking information from another tracking device, determining whether an object coincided with the object specified by the tracking information is included in currently tracked objects; and
an update step of, in a case where it is determined that an object coincided with the object specified by the tracking information is included in the currently tracked objects, replacing an identifier of the object with the identifier included in the tracking information and transmitting to the server device coincidence information which indicates the object received from the nearby tracking device coincides with a currently tracked object, and
the program causing the server device to execute:
a storage step of storing the tracking information transmitted from the tracking device as a graph structure, and storing such that nodes of tracking information which are indicated to coincide with each other in the coincidence information are connected and a node of the identification information of the object is connected to a node of each tracking information.
